(19) United States
(12) Patent Application Publication
(10) Pub. No.: US 2013/0136380 A1
(43) Pub. Date: May 30, 2013

(54) SELECTION TOOL

(71) Applicant: Tony Polichroniadis, Bromley (GB)

(72) Inventor: Tony Polichroniadis, Bromley (GB)

(73) Assignee: ANTHROPICS TECHNOLOGY LIMITED, London (GB)

(21) Appl. No.: 13/700,199

(22) PCT Filed: May 26, 2011
(86) PCT No.: PCT/EP2011/058693

§ 371 Date: Feb. 6, 2013

(30) Foreign Application Priority Data
May 27, 2010 (GB) 1008923.3

(51) Int. Cl. G06T 11/60

(52) U.S. Cl. CPC G06T 11/60
USPC 382/309

(57) ABSTRACT

A method of using a selection tool to apply selection values to a selection mask for a digital image having a plurality of pixels, each pixel having at least one pixel value, wherein the selection mask is arranged to store a selection value for each of the plurality of pixels, the method comprising: displaying on the digital image a selection tool comprising a detection zone and an application zone; determining a characteristic profile of pixel values for pixels of the detection zone based on pixel values stored in the pixels of the digital image within the detection zone; determining a respective selection value for each pixel in the application zone in dependence on a comparison of the at least one pixel value of the pixel and the characteristic profile; and storing the selection values in the selection mask.

### FIELD

The present invention relates to a selection tool. In particular, the present invention relates to a method of using a selection tool to apply selection values to a selection mask for a digital image so that the digital image can be edited.

### BACKGROUND

In image editing, often a user will want to apply an effect (for example brightening, sharpening changing the colour), to a specific area in a digital image. The area that an effect is applied to is often called a selection and is represented with a selection mask or greyscale image, where black indicates the effect is not applied, white indicates the effect is applied fully and grey values in between indicate the effect is partially applied. The black, grey and white values can be stored as numerical values or selection values in the selection mask.

There are many different ways of selecting areas of an image. One of them is to use a mouse controlled brush to select areas. When a mouse button is held down and the mouse moved, a fixed image is painted over the path drawn out by the mouse into the selection mask. The image is often either a hard edged circle for making hard edged selections (as shown in the diagram below), or a soft blob (typically modelled with a Gaussian curve) for making soft edged selections.

One problem with such a technique is that because the brush shape is fixed, area filled rarely coincides with areas within the image one wishes to select.

The present invention seeks to provide an improved selection tool.

### SUMMARY

According to an aspect of the present invention, there is provided a method of using a selection tool to apply selection values to a selection mask for a digital image having a plurality of pixels, each pixel having at least one pixel value, wherein the selection mask is arranged to store a selection value for each of the plurality of pixels, the method comprising: displaying on the digital image a selection tool comprising a detection zone and an application zone; determining a characteristic profile of pixel values for pixels of the detection zone based on pixel values stored in the pixels of the digital image within the detection zone; determining a respective selection value fix each pixel in the application zone in dependence on a comparison of the at least one pixel value of the pixel and the characteristic profile; and storing the selection values in the selection mask.

By determining a respective selection value for each pixel in the application zone in dependence on a comparison of the at least one pixel value of the pixel and the characteristic profile, embodiments of the present invention can in effect allow the active area of the selection tool or brush shape to vary as the tool is moved over the image and, accordingly, a more versatile selection tool with improved editing: control is provided.

Another aspect of the present invention provides a system comprising a memory and a processor, wherein the processor is arranged to perform the above method.

Another aspect of the present invention provides a computer-readable medium having computer-executable instructions adapted to cause a computer system to perform the above method.

Other aspects and features of the present invention will be appreciated from the following description and the accompanying claims.

### BRIEF DESCRIPTION OF THE DRAWINGS

Embodiments of the present invention will now be described, by way of example only, with reference to the accompanying drawings in which like reference numerals are used to depict like parts. In the drawings:

FIG. 1 illustrates a digital image;

FIG. 2 illustrates a selection mask;

FIG. 3 illustrates a characteristic profile;

FIG. 4 illustrates a comparison algorithm;

FIG. 5 illustrates a method in accordance with an embodiment of the invention;

FIGS. 6 and 7 illustrate indicating selection values on the digital image;

FIGS. 8-10 illustrate moving the selection tool;

FIGS. 11 and 12 illustrate methods in accordance with particular embodiments of the invention;

FIG. 13-15 illustrate particular selections;

FIG. 16 illustrates current and previous selection masks;

FIG. 17 depicts histograms and distributions;

FIG. 18 shows a falloff term; and

FIG. 19 is a screen shot of a digital image with the selection tool in use.

### DETAILED DESCRIPTION

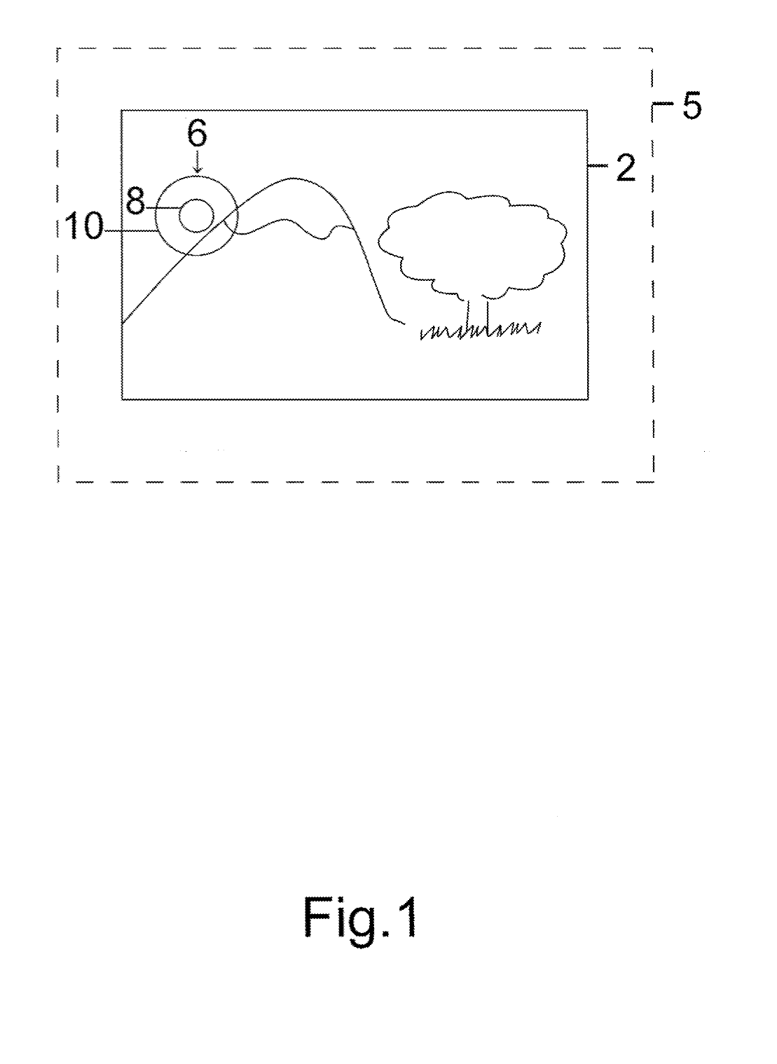

FIG. 1 illustrates a digital image 2 having a plurality of pixels (not shown). Each pixel of the digital image 2 has at least one pixel value, although would typically have more pixels values. A greyscale image may have only one pixel value per pixel, for example. A colour image may have three pixel values, for red, green and blue values, for example.

The digital image 2 of FIG. 1 is displayed on a display 5 of a system or computer such as a general-purpose computer which is configured or adapted to perform the method which will be described. In one embodiment the system (not shown) comprises a processor, memory, and a display. Typically, these are connected to a central bus structure, the display being connected via a display adapter. The system can also comprise one or more input devices (such as a mouse and/or keyboard) and/or a communications adapter for connecting the computer to other computers or networks. These are also typically connected to the central bus structure, the input device being connected via an input device adapter. In operation the processor can execute computer-executable instructions held in the memory and the results of the processing are displayed to a user on the display. User inputs for controlling the operation of the computer may be received via input device(s).

Referring again to FIG. 1, a selection tool 6 comprising a detection zone 8 and an application zone 10 is shown, 13. In some embodiments, for example the depicted embodiment, the detection zone is a circular zone within the application zone which is also a circular zone. In some embodiments, such as the depicted one, the detection zone is surrounded by the application zone. In some embodiments, again such as the depicted one, the detection zone is a subset of the application zone. In some embodiments, again such as the depicted one, the zones are of the same shape. In other embodiments, other shapes and relative positions of the zones can be used.

In some embodiments the size of one or both of the detection zone and the application zone to be varied by a user.

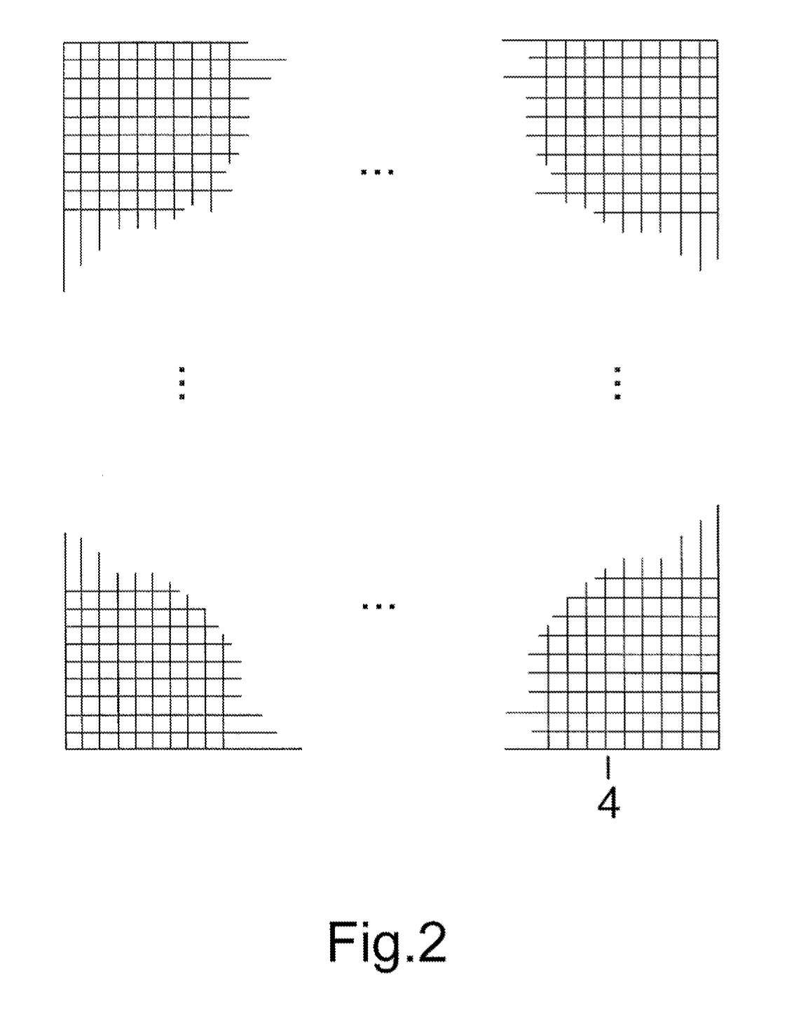

FIG. 2 shows a selection mask 4 which is arranged to store a selection value for each of the plurality of pixels of the digital image 2, for example in an array which has a plurality of elements, each corresponding with a pixel of the digital image 2. The selection values may be values between zero and one, for example where zero represents no selection of the corresponding pixel of the digital image and one represents full selection of the corresponding pixel. Values between zero and one would represent partial selection, for example 0.25 would be a 25% selection and 0.50 would be a 50% selection. Of course, other ranges may be used.

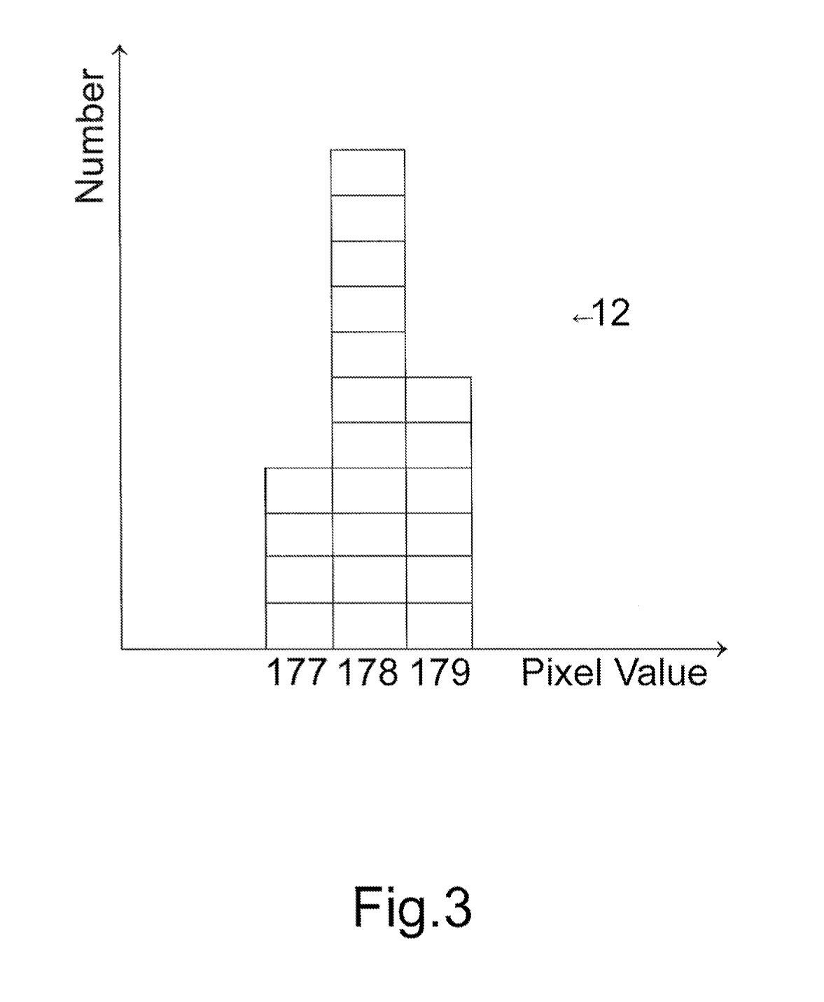

FIG. 3 illustrates how a characteristic profile, for the pixels within the detection zone 8 can be determined. In this example, the pixels of a greyscale digital image of a tree with the sky behind it each have a single pixel value between 0 and 255. The pixels of the image which depict the branch of a tree have pixels values of around 178, and the pixels of the image which depict the sky have values of around 90. The detection zone 8 of the selection tool 6 covers 20 pixels depicting the branch, which all have similar values—that is, they can be considered as a similar shade of grey. Four of the pixels have a value of 177, ten of the pixels have, a value of 178 and six have a value of 179. These three pixel values and the number of pixels having the pixel value are plotted in the histogram of FIG. 3. The values can be normalised against the maximum value of 10, giving the values of 0.4, 1.0 and 0.6 for the pixel values 177, 178 and 179 respectively. The histogram and the normalised values are each examples of a characteristic profile 12 of the pixels of the detection zone.

Now, consider the pixels of the application zone, and imagine that the application zone is covering part of the image showing the branch of a tree and part of the image showing the sky behind the branch so that some of the pixels have values around 178 and others values around 90. The value of each pixel in the application zone can be compared to the characteristic profile 12 and a selection value determined. For the pixels with pixel values near 178 selection non-zero selection values will be determined. For example, the normalised values can be used to give a selection value of 0.4 for pixels values of 177, 1.0 for pixel values, of 178 and 0.6 for pixel values of 179 and these values can be stored in the selection mask for the respective pixels of the image. Values of around 90 for the pixels representing the sky would be compared with the profile and given a zero value as the characteristic profile does not have any values near 90. In this way, the pixels of the image which have similar values to those covered by the detection zone can be selected, but only those ones with similar values and not the ones with dissimilar values (depicting the sky in this example) even though these pixels are covered by the application zone.

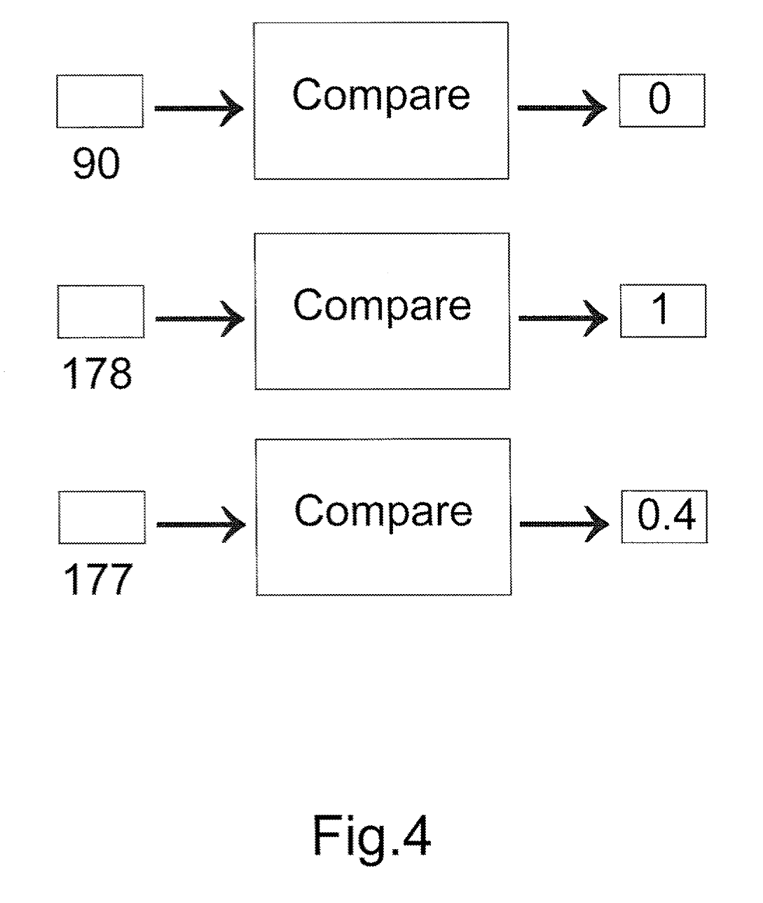

FIG. 4 illustrates the comparison step based on the algorithm described above, though it will be appreciated that a number of different comparison algorithms could be used. In some embodiments, the characteristic profile is a distribution or statistical distribution such as a Gaussian distribution. A particular implementation using histograms will be described later. Some embodiments use other distributions or mathematical equations.

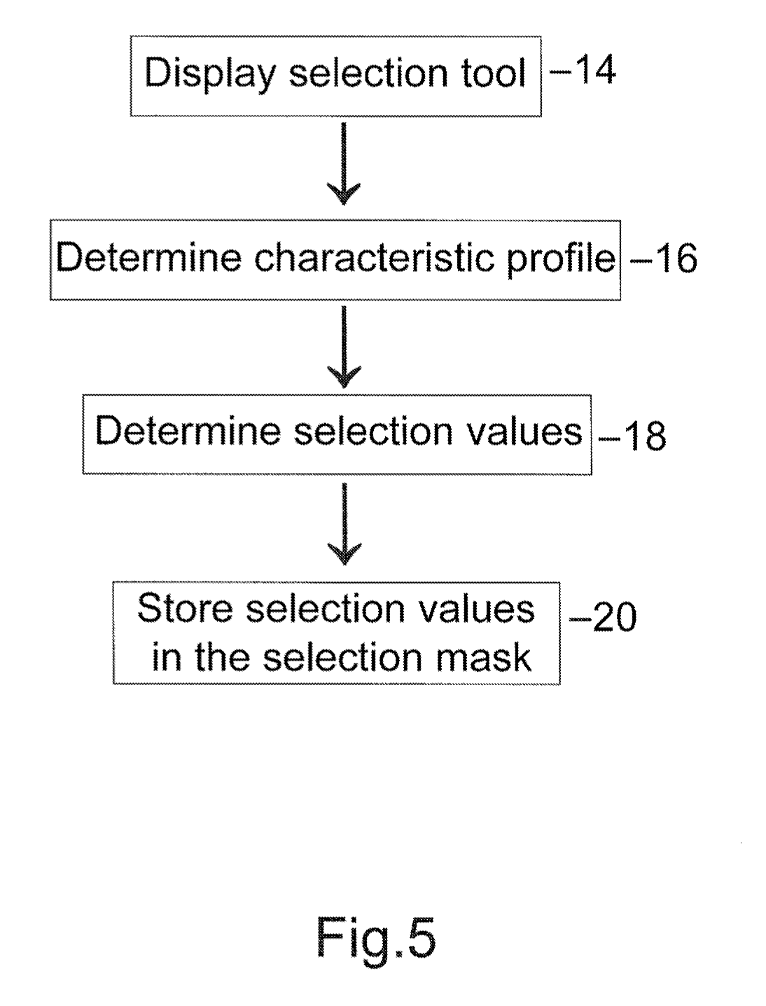

FIG. 5 is a flow diagram which shows the steps of a method in accordance with an embodiment of the invention. With reference to FIG. 3, a method is shown of using a selection tool to apply selection values to a selection mask for a digital image. Referring to the figure, the method comprises in step 14 displaying on the digital image the selection tool, such as the selection tool 6 shown in FIG. 1. In step 16, a characteristic profile of pixel values, such as the profile 12 of FIG. 3, is determined far pixels of the detection zone based on pixel values stored in the pixels of the digital image within the detection zone. In step 18, a respective selection value is determined for each pixel in the application zone in dependence on a comparison of the at least one pixel value of the pixel and the characteristic profile. An example of the comparison step is illustrated in FIG. 4. In step 20, the selection values are stored in the selection mask 4.

Once selection values have been calculated for the pixels of the digital image an effect can be applied to the selected pixels of the digital image, for example the pixel values for the selected, pixels could be darkened in proportion to their respective selection values.

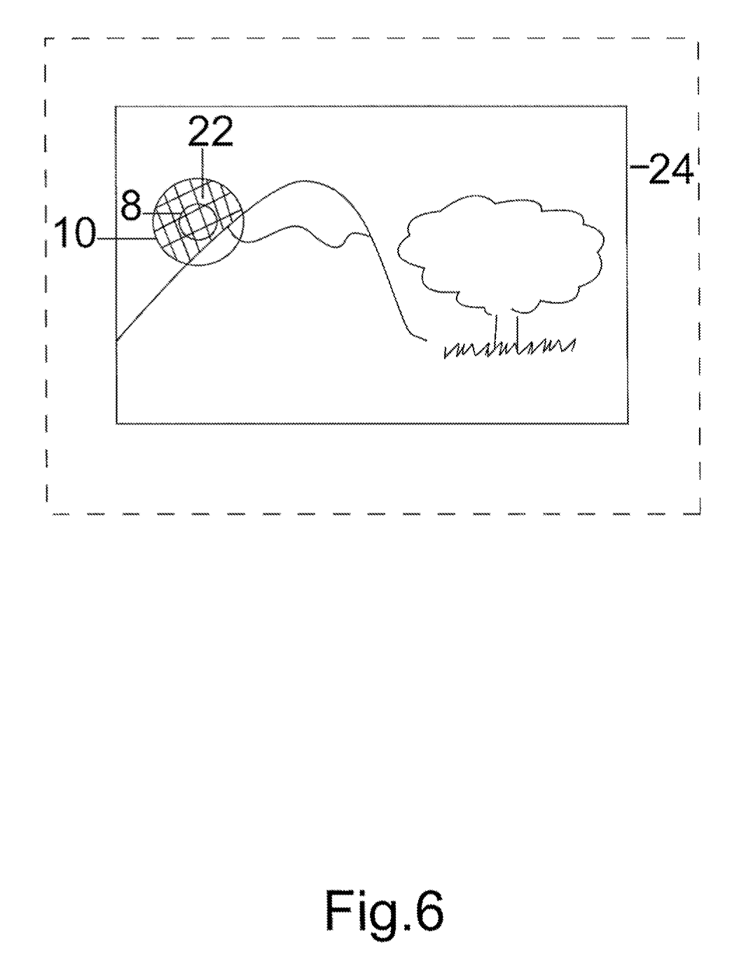

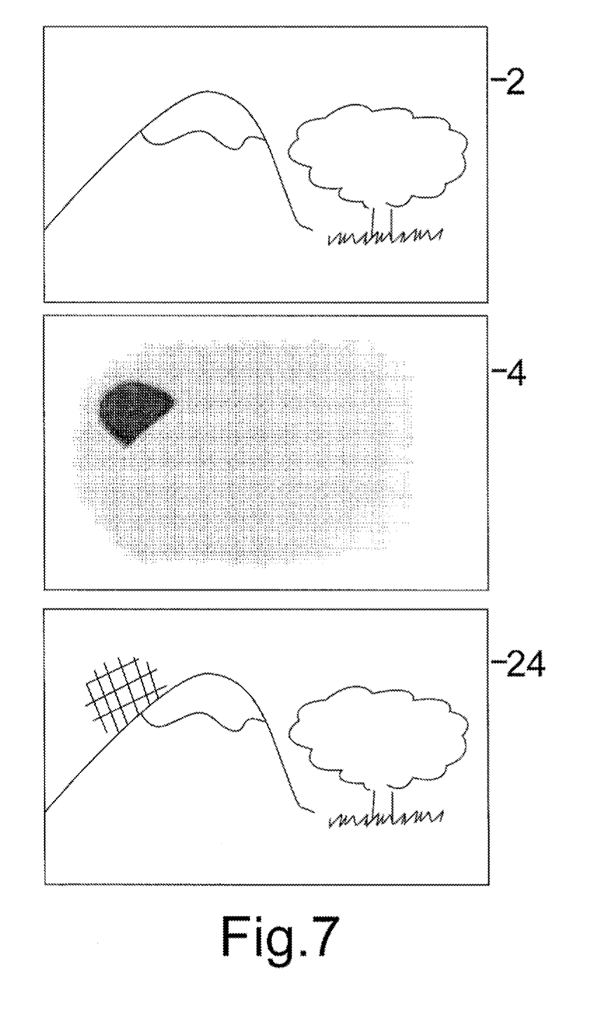

In some embodiments, an indication of the selection values that are stored in the selection mask is shown on the digital image, for example by colouring the pixels that have a selection value a certain colour e.g. red. Optionally, the intensity of the colour is in proportion to the selection values, FIG. 6 illustrates how the selection values are depicted in shaded pixels 22. FIG. 7 illustrates how this is achieved in one embodiment by overlaying the digital image 2 and selection mask 4 on one another to create the combined image 24.

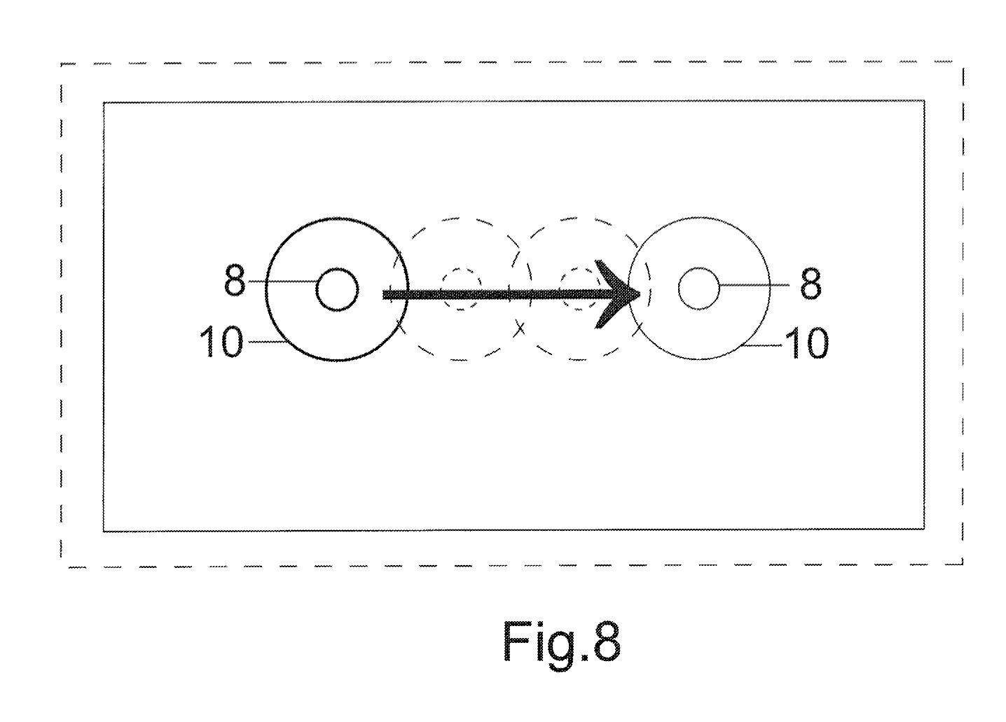

In some embodiments, the detection zone 8 and the application zone 10 are moveable in response to detecting movement using a pointing device, for example as depicted in FIG. 8.

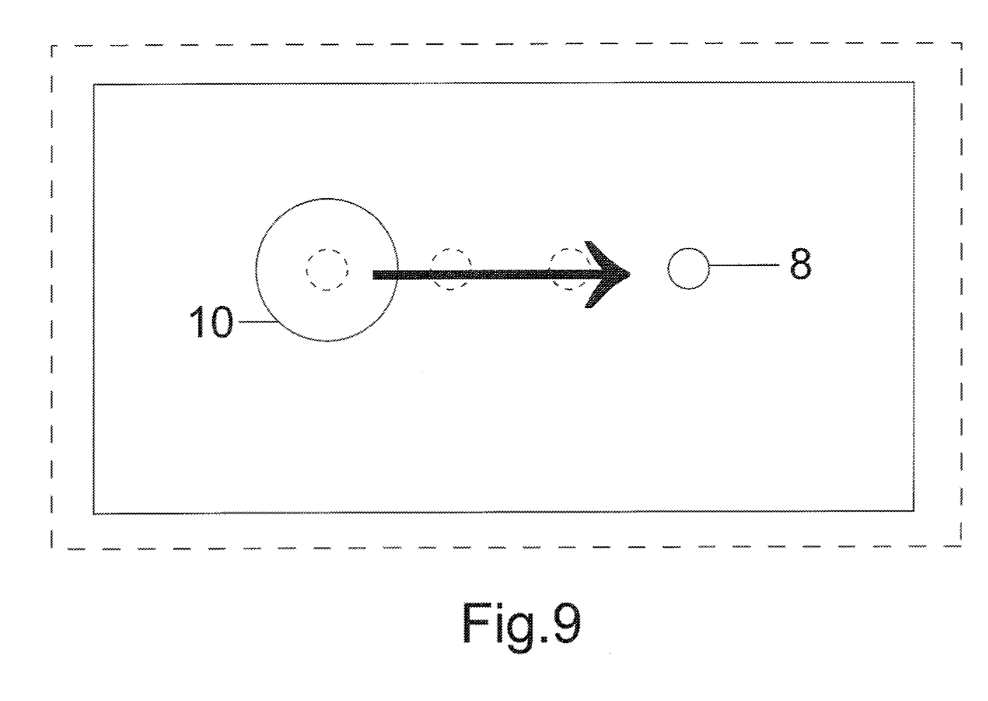

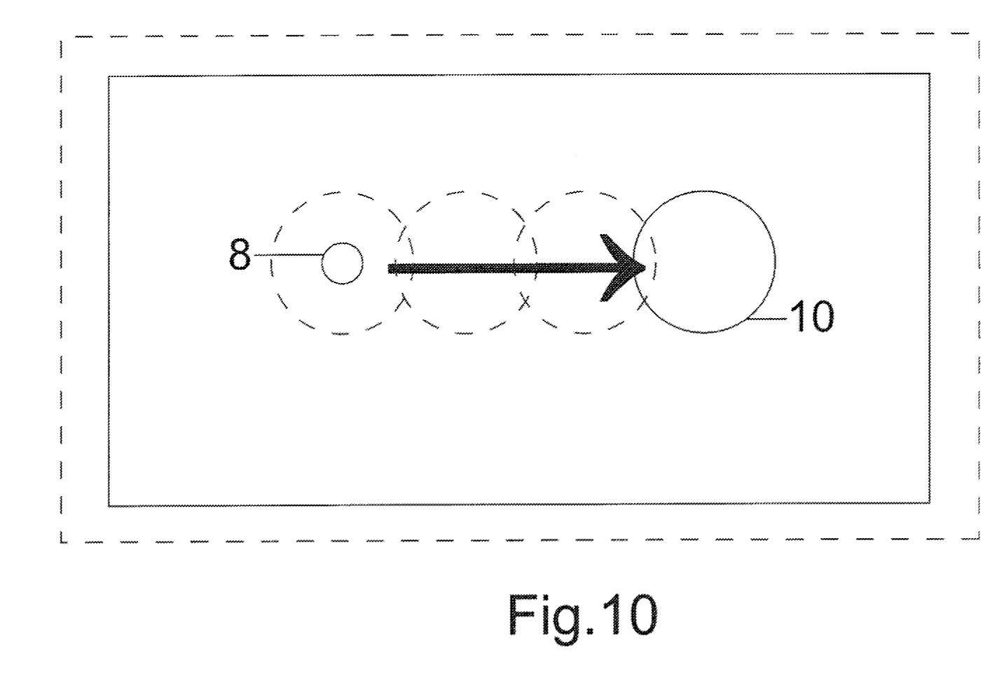

In some embodiments, one of the detection zone or the application is, in response to an appropriate user command such as selecting a button or using a dedicated key stroke, kept stationary as the other is moved in response to detecting movement using a pointing device. FIG. 9 shows the application zone 10 being kept stationary while the detection zone 8 is moved, FIG. 10 shows the detection zone 8 being kept stationary while the application zone 10 is moved.

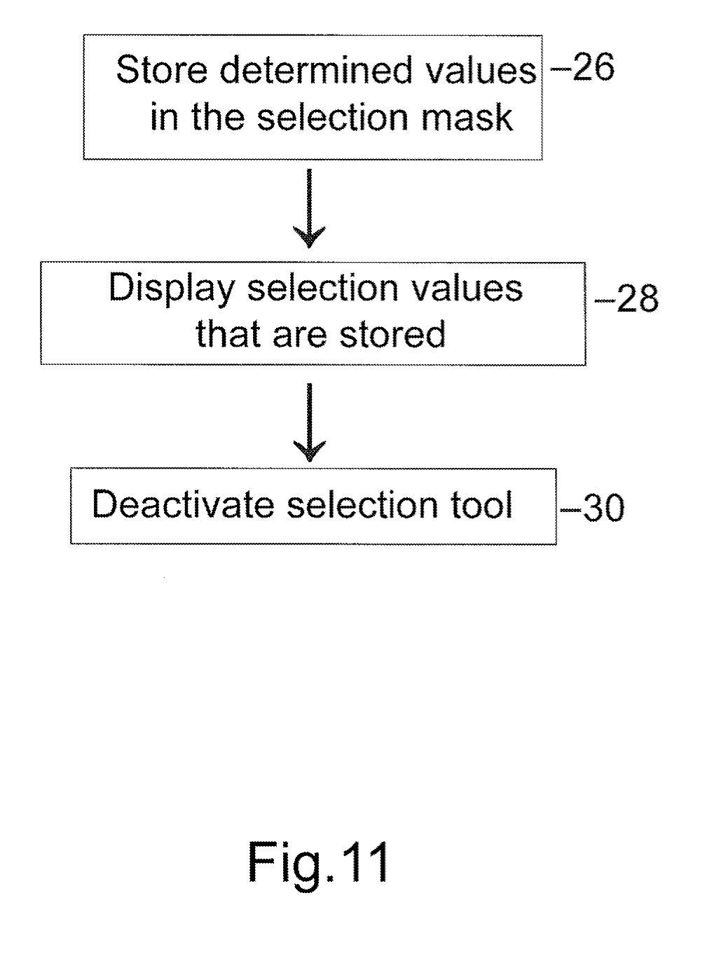

In some embodiments, the selection tool 6 is activated and deactivated in response to detecting activation and deactivation of a pointing device. FIG. 11 illustrates the further steps which can be performed in such embodiments. In step 26, in response to detecting activation of the pointing device, the determined selection values for the pixels within the application zone are stored in the selection mask. In step 28, an indication on the digital image of the selection values that are stored in the selection mask is displayed, such as the indication 22 shown in FIG. 6. In step 30, in response to detecting deactivation of the pointing device, the selection tool is deactivated.

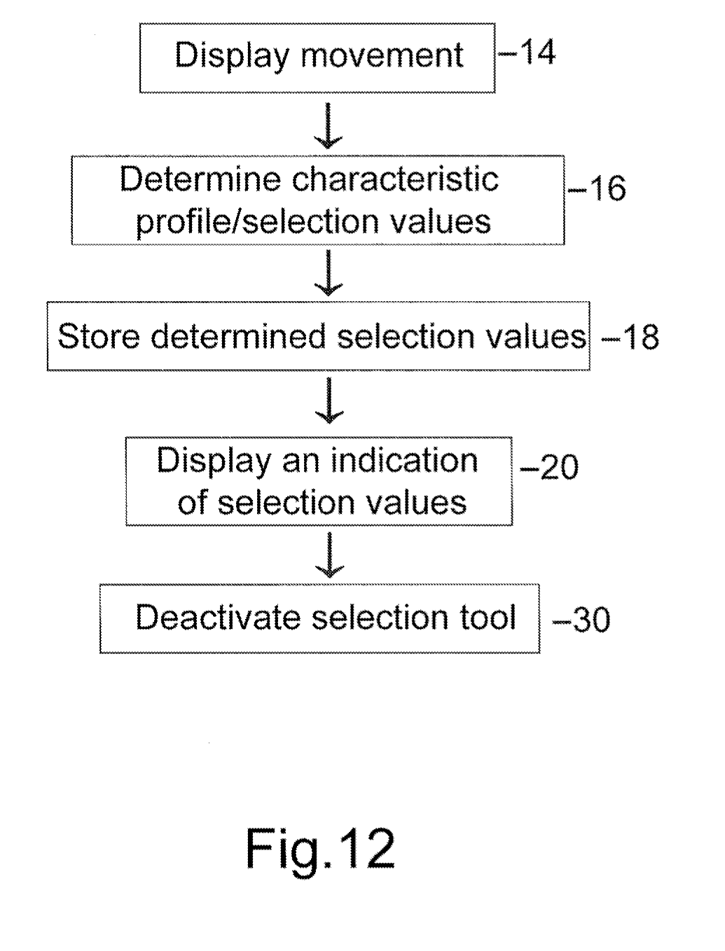

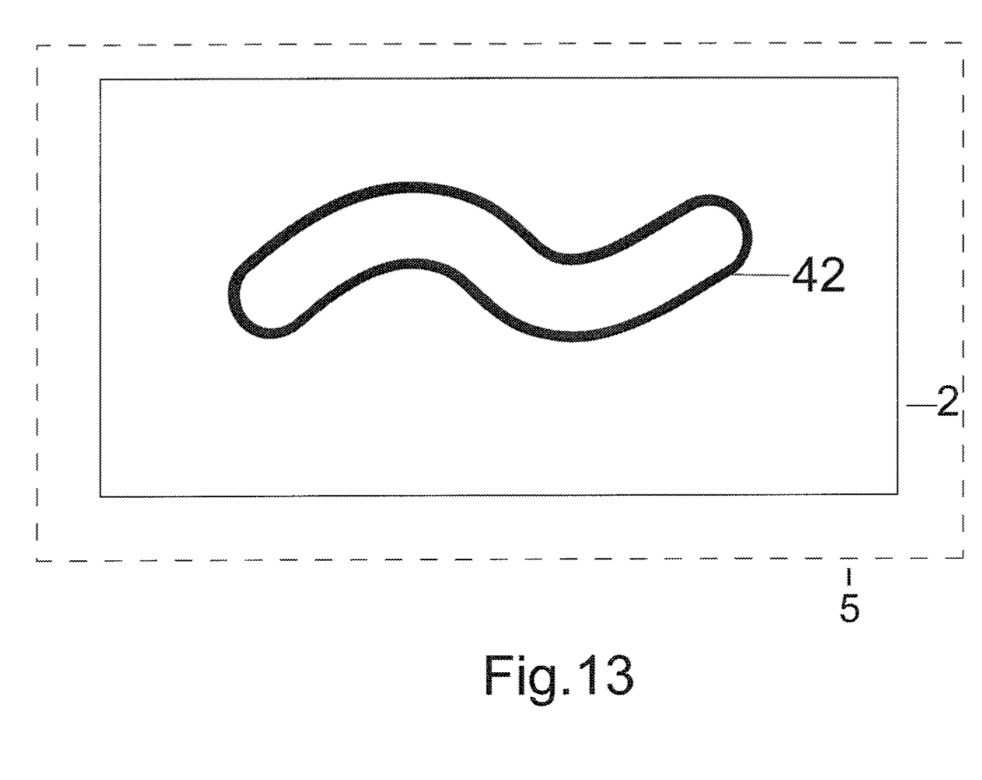

FIG. 12 illustrates the further steps which can be performed in some embodiments. At step 32, in response to detecting movement using the pointing device when activated, movement of the detection zone and/or application zone is displayed (FIGS. 8-10 illustrate the different movements). At step 34, the characteristic profile and/or the selection values for the corresponding pixels of the digital image is/are determined as the detection zone and/or application zone are moved (if the detection zone moves, the characteristic profile, is dynamically redetermined; if the application zone moves the characteristic profile remained unchanged and the selection values for the new pixels within the moving application zone are determined). At step 36, the determined selection values are stored in the selection mask. At step 38, an indication, is displayed on the digital image of the selection values stored in the selection mask. At step 40, in response to detecting deactivation of the pointing device, the selection tool is deactivated. FIG. 13 illustrates a digital image after a selection using, the method depicted in FIG. 12 to move the application zone and detection zone together has been made. The indication 42 of the selection values on the digital image is illustrated.

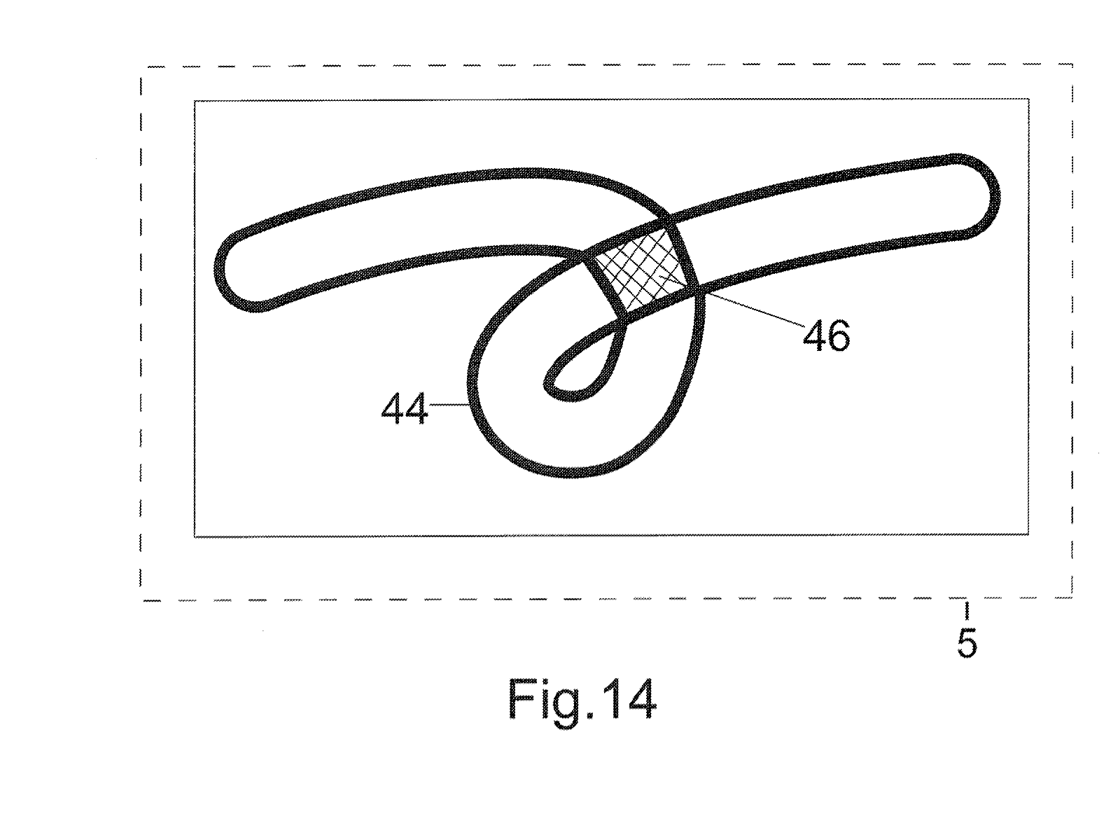

If between activation and deactivation of the pointing device the application zone is moved to select the same pixels of the digital image more than once, the selection values in the selection mask for those pixels are set to the highest determined value. This is illustrated in FIG. 14 where the selection 44 has crossed over itself at the overlapping selection area 46.

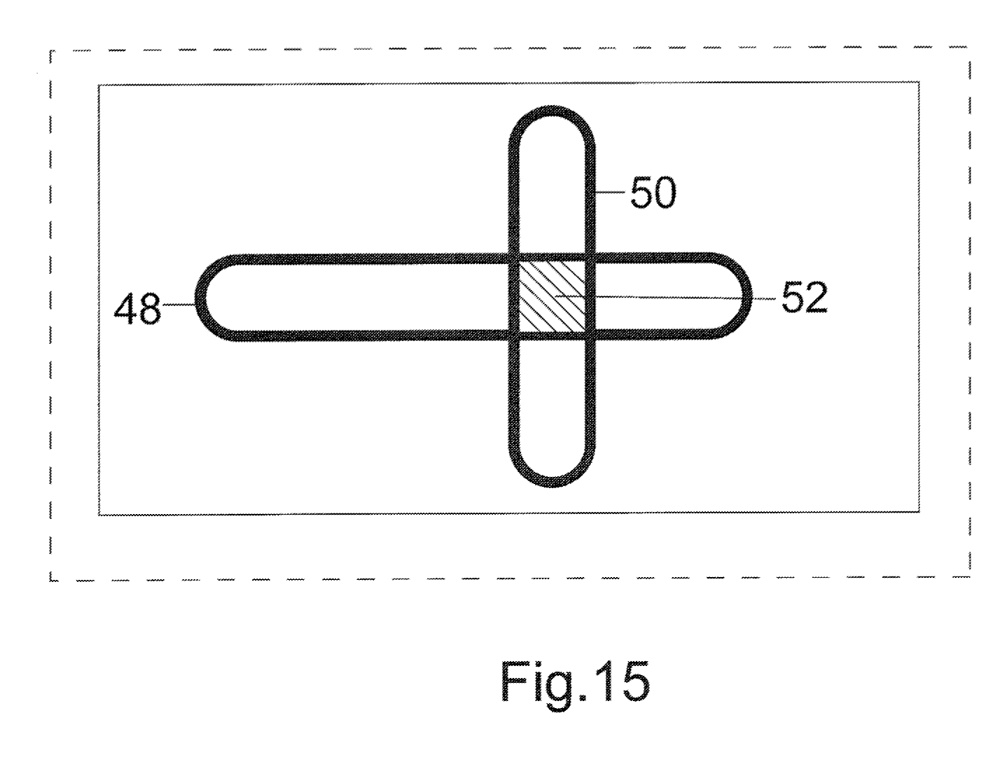

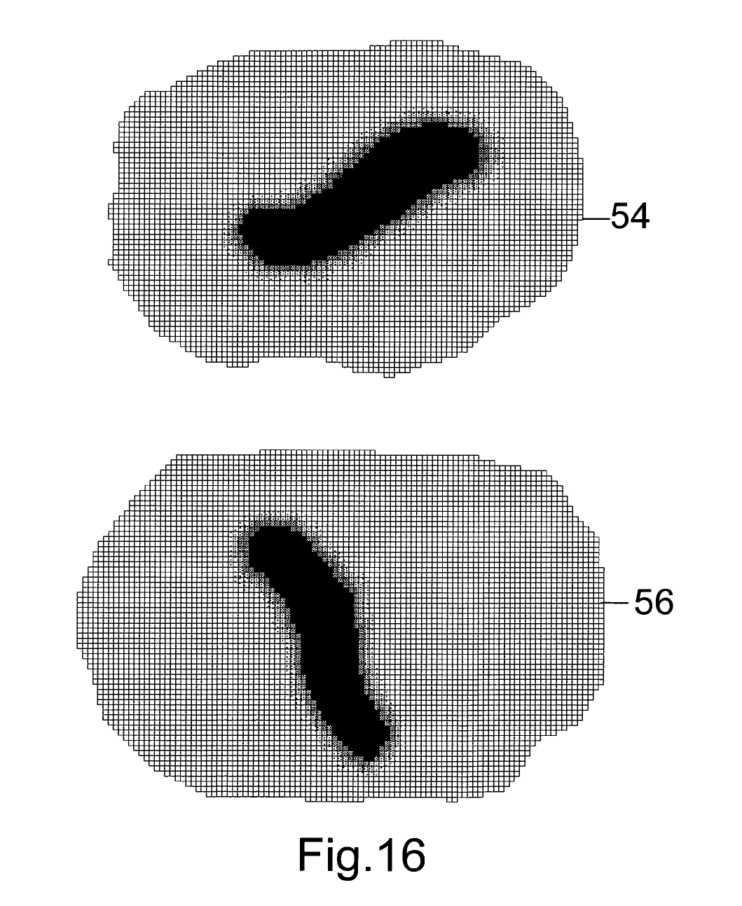

If between activation and deactivation of the pointing device for a current selection the application zone is moved to select pixels of the digital image which were selected, in a previous selection, the selection values in the selection mask for those pixels are based on the sum of the selection values for the previous selection and the selection values for the current selection. For example, the selection values can be simply added together. Typically, where the result of the two values would otherwise exceed a maximum value (denoting full selection of a pixel), the summed value would be set to the maximum value. FIG. 15 illustrates this, where selection 48 has been made in a previous selection and selection 50 in the current selection. The selection values that were selected by both selections, depicted by reference 52, have values based on the sum of the selection values of the previous and current selections. This can be achieved by using a previous selection mask 54 in combination with the current selection mask 56, as depicted in FIG. 16. The values that were applied before the current selection are stored in the previous selection mask 54 and the values for the current selection are stored in the current selection mask. The values held in the two masks can be used to perform the summing calculation.

In some embodiments, in response to detecting movement of the pointing device before it is activated, the selection values for the pixels within the application zone are displayed on the digital image. That is, the selection, values are not displayed until movement of the painting device is detected.

In some embodiments, an erase mode is provided in which the selection tool can be used to erase selection values from the selection mask. The erase mode can decrease selection values, when the corresponding pixels are selected by the tool in erase mode.

In some embodiments, determining the characteristic profile comprises using one or more histograms to represent the distribution of pixel values stored in the pixels of the digital image within the detection zone. In such embodiments, the histograms can be smoothed, optionally scaled and further optionally clamped. Determining a respective selection, value for each pixel in the application zone can also be in dependence on the position of the pixel within the application zone, for example by using a falloff term. These features are exemplified in the description of the following particular implementation in which each pixel of the digital image has pixel values for red, green and blue respectively (denoted as Red, Green and Blue below).

In the particular implementation, the image is first pre-processed into a new colour space with four values per pixel—Brightness, Red′, Green′ and Blue′. These values are calculated using the following equations:

Brightness=max(Red,Green,Blue)

Red′=RED_SCALE*Red/Brightness

Green′=GREEN_SCALE*Green/Brightness

Blue′=BLUE_SCALE*Blue/Brightness

In the above equations “max” calculates the maximum of the Red, Green and Blue values for the pixel. RED_SCALE, GREEN_SCALE and BLUE_SCALE are constants which can be selected to give different prominence to different channels.

This means for a matt object of constant colour, but varying white illumination, only Brightness will vary significantly.

The next step is to generate the characteristic profile by modeling and generalising the distribution of colours in the detection zone of the selection tool to determine which pixels in the application zone should be selected.

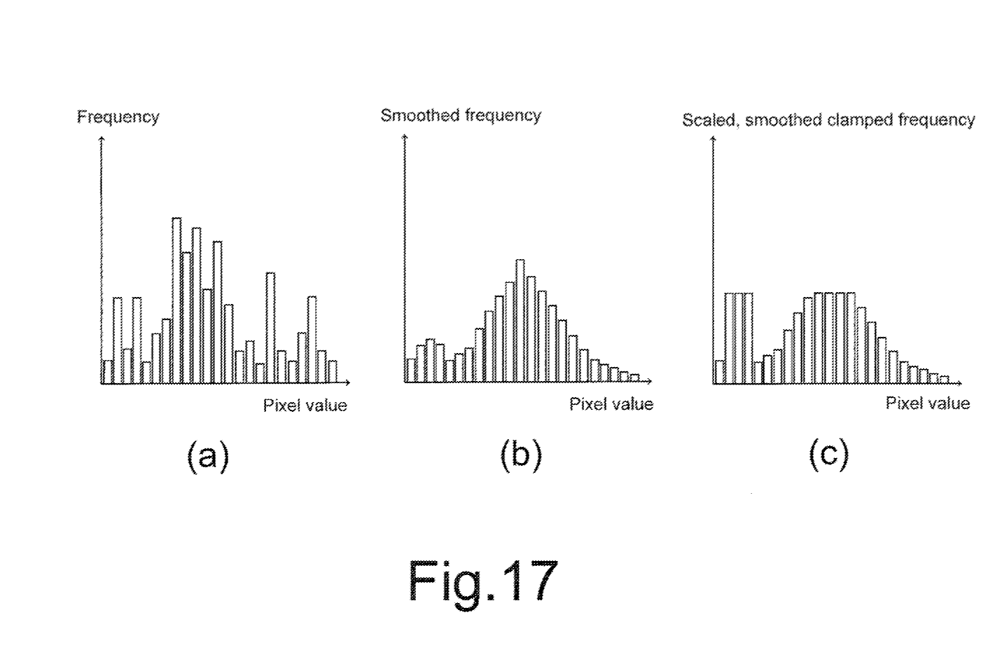

In this implementation four histograms covering Brightness, Red′, Green′ and Blue′ are determined. An example histogram is shown in FIG. 17(a). These histograms are then smoothed as shown in the example of FIG. 17(b). This is to extrapolate values found within the detection zone to similar values. The user has control over how much to blur the histograms. Blurring a lot, means that dissimilar colours to the detection zone may be selected. Blurring a little means that similar colours that are not exactly the same as colours in the detection zone will not be selected. The histograms are then scaled and clamped to the range 0->1 as shown in the example of FIG. 17(c).

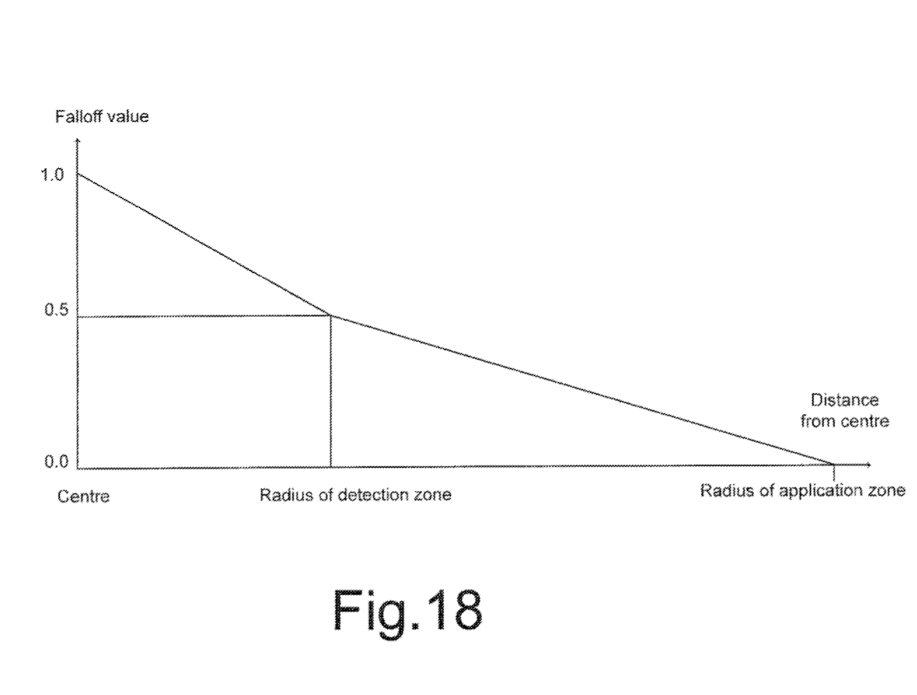

The histograms are used in conjunction with an optional falloff term to keep the edges of the selection tool soft. The falloff term is a radially symmetric function comprising two linear sections as shown in FIG. 18.

The selection value in the selection mask for each pixel within the application zone is updated using the following equations:

Weight=Brightness_Histogram[Brightness]*Red′_Histogram[Red′]*Green′_Histogram[Green′]*Blue_Histogram[Blue′]

NewSelection=Weight*Falloff/(Weight*Falloff+(1−Weight)*(1−Falloff))

Section=Minimum(OldSelection+NewSelection,1)

Selection value=Maximum(Selection,CurrentSelectionValue)

In the above equations, Weight, NewSection and Selection are intermediate values. Brightness, Red′, Green′ and Blue′ are the values for the pixel in the new colour space. The annotation such as Brightness_Histogram[Brightness] denotes looking up a value in the smoothed, scaled and clamped histogram for the index within the square brackets. Falloff denotes the value of the Falloff term based on the position of the pixel within the application zone. OldSelection is the selection value for a previous selection (which could be zero). The Minimum function takes the minimum value of OldSelection NewSelection and 1 so that the value of 1 which denotes full selection is not exceeded. CurrentSelectionValue is the un-updated selection value for the pixel (which could be zero). The maximum function takes the maximum of Selection and CurrentSelectionValue.

A control such as a slider bar may be displayed to enable a user to adjust one or more attributes of the characteristic profile, such as applying a multiplier to the values of the characteristic profile and/or stretching and/or blurring the profile.

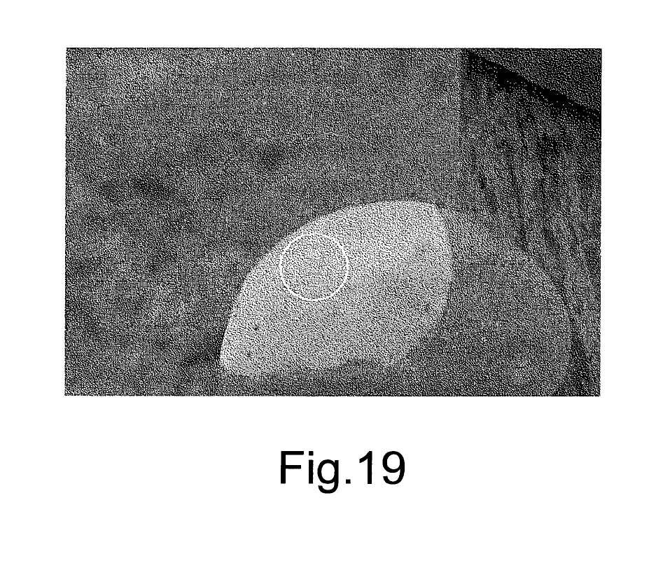

FIG. 19 is an actual screen shot of the selection tool in use on an image of a mushroom. The detection zone and application zone of the tool are shown as well as an indication of the selection values within the application zone.

As mentioned earlier, the digital image can be displayed on a display of a system or computer such as a general-purpose computer. In operation the processor can execute computer-executable instructions held in the memory and the results of the processing are displayed to a user on the display. In a particular implementation, the development environment used is Microsoft Visual Studio, using C++.

A computer readable medium (e.g. a carrier disk or carrier signal) having computer-executable instructions adapted to cause a computer to perform the described methods may be provided.

Embodiments of the invention have been described by way of example only. It will be appreciated that variations of the described embodiments may be made which are still within the scope of the invention.

For example, other mathematical distributions could be used to produce the characteristic profile such as a collection of Gaussian models or a Gaussian mixture model.

1. A method of using a selection tool to apply selection values to a selection mask for a digital image having a plurality of pixels, each pixel having at least one pixel value, wherein the selection mask is arranged to store a selection value for each of the plurality of pixels, the method comprising:
displaying on the digital image a selection tool comprising a detection zone and an application zone;
determining a characteristic profile of pixel values for pixels of the detection zone based on pixel values stored in the pixels of the digital image within the detection zone;
determining a respective selection value for each pixel in the application zone in dependence on a comparison of the at least one pixel value of the pixel and the characteristic profile; and
storing the selection values in the selection mask.

2. A method according to claim 1, the method comprising displaying on the digital image an indication of the selection values that are stored in the selection mask.

3. A method according to claim 1, further comprising:
enabling the detection zone and the application zone to be moved in response to detecting movement using a pointing device.

4. A method according to claim 1, further comprising:
enabling one of the detection zone or the application to be kept stationary as the other is moved in response to detecting movement using a pointing device.

5. A method according to claim 1, wherein the selection tool is activated and deactivated in response to detecting activation and deactivation of a pointing device, the method further comprising:
in response to detecting activation of the pointing device, storing the determined selection values in the selection mask;
displaying on the digital image an indication of the selection values that are stored in the selection mask; and
in response to detecting deactivation of the pointing device, deactivating the selection tool.

6. A method according to claim 5, the method further comprising:
in response to detecting movement using the pointing device when activated, displaying movement of the detection zone and/or application zone;
determining the characteristic profile and/or the selection values for the corresponding pixels of the digital image as the detection zone and/or application zone are moved;
storing the determined selection values in the selection mask;
displaying on the digital image an indication of the selection values stored in the selection mask; and
in response to detecting deactivation of the pointing device, deactivating the selection tool.

7. A method according to claim 6, wherein if between activation and deactivation of the pointing device the application zone is moved to select the same pixels of the digital image more than once, the selection values in the selection mask for those pixels are set to the highest determined value.

8. A method according to claim 6, wherein if between activation and deactivation of the pointing device for a current selection the application zone is moved to select pixels of the digital image which were selected in a previous selection, the selection values in the selection mask for those pixels are based on the sum of the selection values for the previous selection and the selection values for the current selection.

9. A method according to claim 4, further comprising:
in response to detecting movement of the pointing device before it is activated, displaying on the digital image the selection values for the pixels within the application zone.

10. A method according to claim 1, wherein an erase mode is provided in which the selection tool can be used to erase selection values from the selection mask.

11. A method according to claim 1, wherein determining the characteristic profile comprises using one or more histograms to represent the distribution of pixel values stored in the pixels of the digital image within the detection zone.

12. A method according to claim 11, wherein the histograms are smoothed, optionally scaled and further optionally clamped.

13. A method according to claim 1, wherein the detection zone is a circular zone within the application zone which is also a circular zone.

14. A method according to claim 1, further comprising enabling the size of one or both of the detection zone and the application zone to be varied by a user.

15. A method according to claim 1, wherein determining a respective selection value for each pixel in the application zone is also in dependence on the position of the pixel within the application zone.

16. A method according to claim 1, further comprising displaying a control to enable a user to adjust one or more attributes of the characteristic profile.

17. A computer comprising a memory and a processor, wherein the processor is adapted to perform the method of claim 1.

18. A computer readable medium having computer-executable instructions adapted to cause a computer to perform a method of claim 1.
